(19) United States
(12) Patent Application Publication
(10) Pub. No.: US 2015/0165635 A1
(43) Pub. Date: Jun. 18, 2015

(54) Cutting device and method for cross-cutting a moving fiber web

(71) Applicant: VOITH PATENT GMBH, HEIDENHEIM (DE)

(72) Inventors: Christian Pringal, Krefeld (DE); Hubert Brand, Grevenbroich (DE); Michael Schmitz, Duesseldorf (DE); Marco Peters, Straelen (DE)

(21) Appl. No.: 14/415,791

(22) PCT Filed: Jun. 21, 2013
(86) PCT No.: PCT/EP2013/063002

§ 371 Date: Jan. 20, 2015

(30) Foreign Application Priority Data
Jul. 19, 2012 (DE) 102012212656.2

(51) Int. Cl. B26F 1/20; B26F 1/08; B26F 3/02

(52) U.S. Cl. CPC B26F 1/20; B26F 3/02; B26F 1/08

(57) ABSTRACT

A cutting device for perforating a running fibrous material web transversely to the web running direction has a first row of blades with a plurality of tips. A displacement device moves the row of blades with a motion component in the web running direction and a motion component perpendicular to the web running direction. Transverse separation by perforation and subsequent tearing is improved, particularly for heavy fibrous material webs (>250 g/mm²), by providing a second row of blades, which has a plurality of tips and which is also displaceable by a displacement device approximately simultaneously with the first row of blades. Cuts are made in the running fibrous web at a spacing distance between the cuts made by the first row of blades and the cuts made by the second row of blades in the web running direction of at least 1 mm, preferably at least 3 mm.

The invention relates to a cutting device for the perforation of a moving fiber web transversely with respect to its web running direction, having a first row of knives with a plurality of tips which is equipped with a displacement device which makes the row of knives movable with a movement component in the web running direction and a movement component perpendicular to the web running direction.

The invention relates further to a method for cross-cutting a fiber web in the web running direction before or on a finished fiber web reel, the fiber web being perforated and a tensile stress then being applied to the fiber web, so that the web tears at the perforation.

Many fiber webs are produced virtually continuously. This applies in particular to paper or board webs. Webs of this type frequently have to be wound up during production, but in any case at the end of production, onto fiber web reels, which are able to accommodate only a finite quantity of the product web. Accordingly, from time to time such product webs have to be severed transversely with respect to their running direction. The term “row of knives” is not necessarily to be understood here to mean a plurality of individual knives which can each produce a perforation slit, connected one after another in a row, but a single knife blade having a plurality of tips or points or needles arranged one after another is also to be subsumed therein. Each tip, point or needle is then used to achieve weakening of the fiber web by means of piercing.

In one type of severing, two steps are necessary. The product web is initially cut in the manner of a perforation by using the cutting device, such that a row of relatively short cuts beside one another in a row is introduced. Lands, at which the product web is still continuous, remain between the short cuts. This cut, which can also be referred to as a perforation line, can be introduced at a certain distance from the actual dividing point. The actual dividing is then carried out later, by the product web being subjected to an increased tensile stress at a specific position. Here, the remaining lands then tear off. Such a procedure has the advantage, for example, that the already weakened or perforated product web can still run through a part of a processing device, in order for example to be provided locally with an application of adhesive or to reach a reeling-start position.

Cutting devices of this type and methods for cross-cutting fiber webs are known to those skilled in the art. EP 1 010 503 A2 reproduces the prior art here very well. In this disclosure, attempts are already made, by means of the mutual displacement of two pointed knives lying on each other, to be able to make the individual perforation cuts of the perforation line different and adjustably wide. This would have the advantage of being able to weaken lightweight and heavy fiber webs with different intensities.

However, it has transpired that even relatively wide perforation cuts do not lead to a satisfactory result in the case of heavy fiber webs, that is to say in particular in boards. In addition, relatively narrow remaining lands often cannot tear off as a result of pure tensile stresses on the fiber web without creases occurring in the web. The necessary dividing forces, even in the case of remaining land widths of 1 mm, are so high that the method does not proceed without complications.

It is therefore the object of the invention to improve the cross-cutting by means of perforation and subsequent tearing, in particular in heavy fiber webs (>250 g/m²).

With regard to the cutting device, the object is achieved in that, via a second row of knives, which has a plurality of tips and which can likewise be adjusted via a displacement device, perforation cuts can be introduced into the moving fiber web, approximately simultaneously with the first row of knives, in such a way that the spacing of the perforation cuts of the first row of cuts and that of the second row of cuts in the web running direction is at least 1 mm, preferably at least 3 mm.

The aforesaid movement component in the web running direction should correspond substantially to the web speed, at least as long as the knife tips have been inserted into the web. As a result, fine, usually straight, short cuts are produced transversely with respect to the web running direction without excessively high forces in the web running direction being exerted on the tips by the web. Particularly preferably, this component in the web running direction can be adjusted, in order, if appropriate, to be able to match different web speeds.

It has transpired that the use of a second row of knives weakens the fiber web in such a way that tearing as a result of the application of tensile force is made considerably easier, even in the case of heavy grammages. Surprisingly, it has been shown that, when tensile forces are applied to the fiber web perforated in this way, connecting tears with at least one component in the web running direction can be produced substantially more easily than to divide the web lands between the perforation cuts transversely thereto. Here, it is preferred if the tips of the two rows of knives are ground on one side, specifically each on the same side as seen in the web running direction. Each perforation cut then exhibits a small angle, the point of which points in the same direction. As a result, the paper web is not compressed.

Here, it is advantageous if the tips of both rows of knives in the multiplicity are not aligned in the web running direction. The perforation cuts of the second row of knives then end approximately where the perforation cuts of the first row of knives begin. By means of the subsequent application of tensile forces, the notch effect can be utilized in such a way that the tear runs in the web running direction and joins the ends of the cuts. The edge torn off is somewhat pointed as a result but is not associated with any problems during the winding onto a new reel core or during adhesive bonding to the circumference of the finished roll.

In order to reliably permit the simple connecting tear running with considerably lower forces to be applied with a component in the web running direction, it is advantageous if the cuts of the second row of cuts cover the lands remaining between the cuts of the first row of cuts. Each connecting tear running in the web running direction, starting from the first row of cuts, then reliably meets a further cut of the second row of cuts.

The rows of knives are preferably arranged in such a way that they are parallel during the perforation of the fiber web. This ensures that no different tensile forces, which in turn can contribute to creasing, have to be applied over the web width.

Advantageously, care is taken that the displacement devices for the first row of knives and the second row of knives are identical. In this way, a considerable amount of overall space is saved.

Preferably, the tips are arranged vertically adjustably on the row of knives. With such adjustability, the cut widths of the individual perforation cuts can be made variable in their length.

Likewise, it is preferred for the spacing of the rows of knives to be adjustable. As a result, it is possible to react very well to different fiber web thicknesses.

Preferably, at least one row of knives is arranged on a roll. Via a rotary drive, the row of knives can rotate into the web while the latter is touching the circumference of the roll. Returning the row of knives into the initial position is carried out in a simple way via a 360° rotation of the roll. The circumferential speed of the roll can also be adjusted without difficulty to the web speed. However, other displacement devices, such as a lever rocker or a four-link mechanism, are also not excluded from the protective scope.

It is advantageous if a resilient element is provided, on which the moving fiber web can be supported and into which at least some knife tips can dip during the perforation of the fiber web. As a result, the moving fiber web is not forced to the side by the knife tips during the perforation. The fiber web is therefore supported while the knife tips introduce short cuts.

Preferably, the resilient element is arranged to be movable by a displacement device. As the knives are dipped into the web, said resilient element can move concomitantly on the opposite web side. The at least one row of knives and the resilient element preferably move synchronously on the opposite sides of the fiber web at the web speed, at least as long as the knife tips dip into the fiber web and effect the perforation cuts.

Quite particularly preferably, the resilient element is formed by a brush. It has transpired that such a brush supports the fiber web very well during the cutting but the knives do not damage the resilient element, as a result of the fact that they can dip between the bristles.

With respect to the method for cross-cutting a fiber web in the web running direction before or on a finished fiber web reel, the object of the invention is achieved in that the perforation produced by knife tips has two rows transversely with respect to the fiber web running direction. As already explained, the connecting tears produced by the tension can be produced more simply and the whole of the width of the fiber web can be divided more easily. This is because the attempt to tear apart remaining transverse lands of a row of knives is surprisingly considerably more of a problem than producing the tears from the first row of knives to the second row of knives.

Here, the cutting device for the perforation of a moving fiber web according to one of claims 1 to 11 is preferably used.

The tensile stress is preferably produced by a displacement of the fiber web reel. When the roll is finished, it must in any case be removed from the winding device. As a result of ejecting the full wound roll, a tensile stress, which leads to tearing of the fiber web at the perforated point, is automatically produced. It is thus possible to save a separate step, which is to the benefit of the required high cycle numbers.

Particularly preferably, the perforation is formed in such a way that, as a result of producing the tensile stress, shear stresses, which are decisive for the tearing of the fiber web, are produced. These shear forces act from the perforation cuts of the first row of cuts produced by the first row of knives to the perforation cuts of the second row of cuts produced by the second row of knives, and permit the smallest application of force in order to divide the web.

The invention will be explained in more detail below by using exemplary embodiments with reference to the drawings, in which

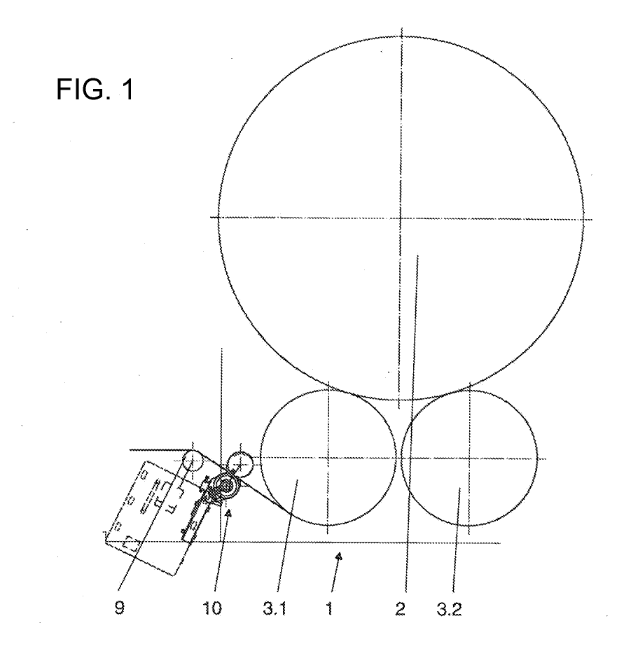

FIG. 1 shows a schematic, partly sectioned illustration of a roll winding device with cutting device according to the invention connected upstream,

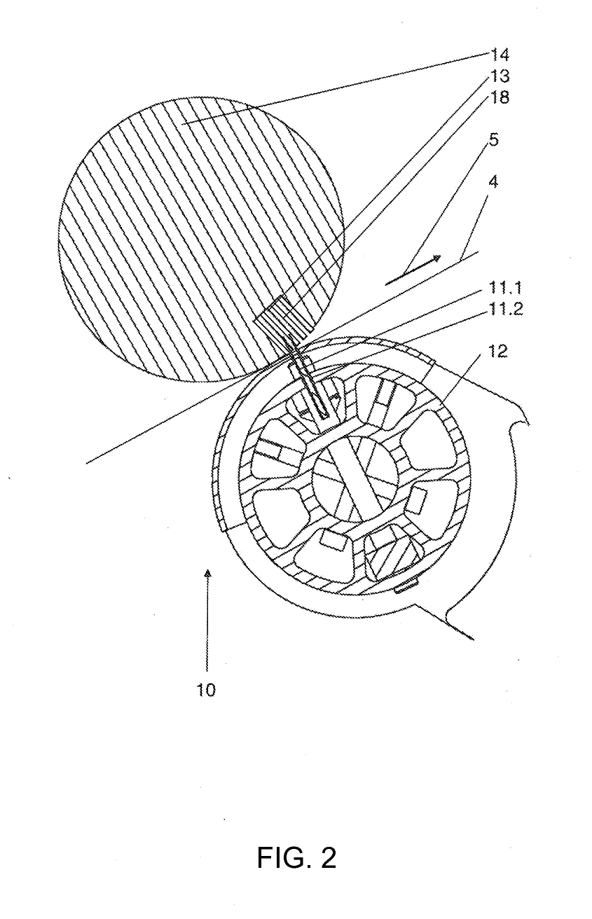

FIG. 2 shows an enlarged illustration of the cutting device,

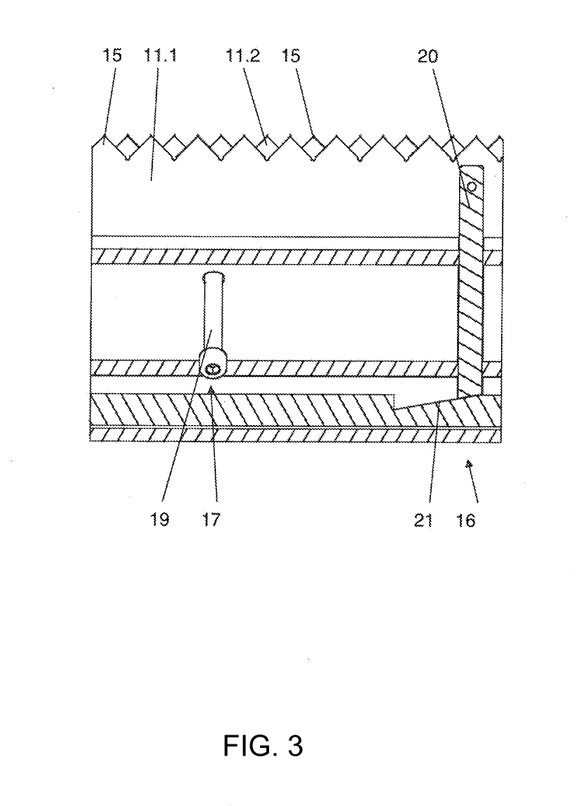

FIG. 3 shows rows of knives and their displacement devices, and

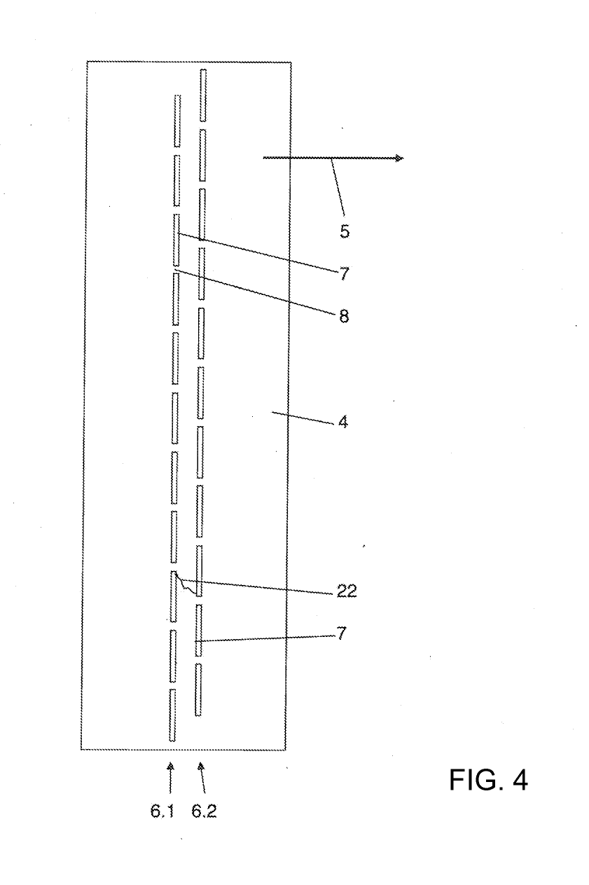

FIG. 4 shows a perforated fiber web.

FIG. 1 shows a roll winding device 1. Here, a roll 2 is supported on two rotatable carrier rolls 3.1, 3.2. The fiber web 4 supplied runs through the gap between the carrier rolls 3.1, 3.2 and is finally wound onto the roll 2 driven by the carrier rolls 3.1, 3.2. Once a desired roll diameter has been reached—for example of the size precisely illustrated in FIG. 1—then the fiber web 4 supplied must be divided. For this purpose, before it is wound up and after it has passed an adjustable guide roll 9, the fiber web runs through the cutting station 10 according to the invention.

The cutting device 10 is illustrated enlarged in FIG. 2. It comprises two displacement devices in the form of rolls 12, 14, between which the fiber web 4 runs. The first displacement device 12 carries two rows of knives 11.1, 11.2. According to the invention, these have a minimum spacing of 1 mm, preferably at least 3 mm. On the opposite side of the fiber web 4, the second displacement device 14 (likewise a roll) carries a resilient element 13. Both rolls 12, 14 can reach a circumferential speed which corresponds substantially to the fiber web speed. In the web running direction 5, the two rows of knives 11.1, 11.2 accordingly dip into the moving fiber web 4 and cut the latter transversely with respect to the web running direction 5. In the process, the knives stick into the resilient element 13, which is preferably formed by a brush 18. The rows of knives therefore complete a movement component in the web running direction (at at least approximately the same speed as the fiber web), and a movement component perpendicular to the web running direction.

The two rows of knives are illustrated in FIG. 3. Here, the second row of knives 11.2 is located behind the first row of knives 11.1. It can be seen in FIG. 3 that the knife tips 15 of the individual rows of knives 11.1, 11.2 are not aligned. A spacing adjustment device 17 of the rows of knives 11.1, 11.2 is indicated by an adjusting screw 19. And, as a result of the ability to displace a holder 20 on an inclined support 21, in this exemplary embodiment a height adjustment device 16 of at least one knife tip 15 is implemented.

By means of the last-named height adjustment device 16 of the knife tip 15, the length of each perforation cut 7 can be defined. This becomes particularly clear in FIG. 4. It is possible to see the two parallel rows of cuts 6.1, 6.2 with the perforation cuts 7. Although the lands 8 between the perforation cuts of a row of cuts are certainly short, they nevertheless offer excessively high resistance as the fiber web is divided on account of applied tensile stresses. In actual fact, the web then tears on account of shear stresses produced at connecting tears 22 (one of these is illustrated by way of example). These tears can be produced very easily because of shear forces that arise and that are built up by the tensile stress in the web, and lead to simple division even of heavy fiber web weights. It should be emphasized that the invention can of course also comprise more than two rows of knives 11.1, 11.2.

### LIST OF DESIGNATIONS

1 roll winding device

2 roll

3.1, 3.2 carrier toll

4 fiber web

5 web running direction

6.1, 6.2 row of cuts

7 perforation cut

8 land

9 guide roll

10 cutting device

11.1, 11.2 row of knives

12 displacement device, roll for row of knives

13 resilient element

14 displacement device, roll for resilient element

15 knife tip

16 height adjustment device of the knife tip

17 spacing adjustment device of the row of knives

18 brush

19 adjusting screw

20 holder

21 inclined support

22 connecting tear

1-15. (canceled)

16. A cutting device perforating a moving fiber web transversely with respect to a web running direction, the cutting device comprising:
a first row of knives having a plurality of tips;
a displacement device carrying said first row of knives for movement with a motion component in the web running direction and a motion component perpendicular to the web running direction;
a second row of knives having a plurality of tips and being carried for movement by a displacement device;
wherein said first row of knives and said second row of knives are configured to introduce perforation cuts into the moving fiber web approximately simultaneously and wherein a spacing distance between the perforation cuts along a first row of cuts effected by said first row of knives and the perforation cuts along a second row of cuts effected by said second row of knives along the web running direction amounts to at least 1 mm.

17. The cutting device according to claim 16, wherein the spacing distance between said first row of cuts and the second row of cuts in the web running direction amounts to at least 3 mm.

18. The cutting device according to claim 16, wherein a majority of said tips of said first and second rows of knives are not aligned with one another in the web running direction.

19. The cutting device according to claim 16, wherein the perforation cuts of the second row of cuts cover respective lands remaining between the perforation cuts of the first row of cuts.

20. The cutting device according to claim 16, wherein said rows of knives are disposed to be parallel during a perforation of the fiber web.

21. The cutting device according to claim 16, wherein said displacement device for said first row of knives and said second row of knives is a single displacement device.

22. The cutting device according to claim 16, wherein said tips are vertically adjustably mounted on each of said first and second rows of knives.

23. The cutting device according to claim 16, wherein a spacing distance between said first and second rows of knives is adjustable.

24. The cutting device according to claim 16, wherein at least one of said row of knives is mounted on a roll.

25. The cutting device according to claim 16, which further comprises a resilient element for supporting a moving said fiber web, and wherein at least some of said plurality of tips dip into said resilient element during the perforation of the fiber web.

26. The cutting device according to claim 25, wherein said resilient element is mounted for movement by a displacement device.

27. The cutting device according to claim 2, wherein said resilient element is a brush.

28. A method of cross-cutting a fiber web before or on a finished fiber web reel in the web running direction, the method comprising:
perforating the fiber web with knife tips forming a perforation having a first row of cuts and a second row of cuts extending transversely with respect to a fiber web running direction, wherein a spacing distance between perforation cuts of the first row of cuts and perforation cuts of the second row of cuts in the web running direction amounts to at least 1 mm; and
subsequently subjecting the fiber web to tensile stress causing the fiber web to tear at the perforation.

29. The method according to claim 28, which comprises forming the perforation with the first row of cuts spaced from the second row of cuts along the web running direction at least 3 mm.

30. The method according to claim 28, which comprises producing the perforation with a cutting device according to claim 16.

31. The method according to claim 28, which comprises introducing the tensile stress by displacing the fiber web reel.

32. The method according to claim 28, which comprises forming the perforation such that, as a result of producing the tensile stress, shear stresses are produced that are decisive for a tearing of the fiber web.
